(19) United States
(12) Patent Application Publication
(10) Pub. No.: US 2011/0278334 A1
(43) Pub. Date: Nov. 17, 2011

(54) Individually adaptable universal organizing container for auto sundry

(76) Inventor: Jorg Aadahl, San Mateo, CA (US)

(21) Appl. No.: 13/066,954

(22) Filed: Apr. 28, 2011

Related U.S. Application Data
(60) Provisional application No. 61/343,360, filed on Apr. 28, 2010.

(51) Int. Cl. B60R 7/00

(52) U.S. Cl. 224/275

(57) ABSTRACT

An individually adaptable organizing container consisting of a bottom part, four interlocking sidewalls, and a leveling and holding mechanism for the passenger seat of an automobile, with customized, interchangeable containers of various sizes designed to hold the assortment of items that a driver or passengers like children in the back seat may need or want, optionally including a utility light and other conveniences. The container holds previously scattered items in secure, predetermined, more convenient and more easily accessible place, thus enhancing the quality of the driving experience, improving traffic safety and reducing risk of injury resulting from attempts at reaching objects out of normal range or scattered after an abrupt stop. Placed in the back seat on an adjustable holding frame, the container separates children and holds food items and toys needed to keep them occupied while travelling.

### CROSS-REFERENCE TO RELATED APPLICATIONS

This application claims the benefits of Provisional Patent Application filed Apr. 28, 2010: Application No. 61/343,360, Confirmation No. 2651

### FEDERALLY SPONSORED RESEARCH

Not Applicable

### SEQUENCE LISTING

Not Applicable

### BACKGROUND OF THE INVENTION

1. Field of Invention

This invention relates to the automotive after-market and is introduced as a solution to the inconvenience, associated traffic hazards, and risk of injury incurring whenever the driver of an automobile searches or reaches for various items kept on the dash board, on the unoccupied passenger seat, in the glove compartment, in an armrest console, in door pockets on both sides, or from the floor of the car. The object is specifically to enhance traffic safety, as well as driver convenience and comfort by providing an improved accessory for keeping organized the assortment of articles often loosely surrounding the driver of a vehicle, and also to keep back seat passengers entertained and occupied.

2. Discussion of Prior Art

While a variety of arm rest consoles or baskets to fit between the seats, to hang on the backrest, or placed on the passenger seat are designed to offer some relief for certain items like cups of liquid, toll coins and the like, there is no complete, universal and individually adaptable solution and safe method of storing the wide variety of items that the driver may need or want while operating a vehicle, like note pad and writing instruments; maps; light for reading maps and directions; keys; money; sunglasses; parking card and credit cards; tissue box; store coupons and shopping list; tapes and CDs; goodie container; flashlight and other emergency items; pills and medication; trash; cloth for wiping windows; cell phone; camera; hand bag; cosmetics; smoking paraphernalia; mail; etc. An occupant of the passenger seat may provide some help, but someone driving alone will often have to reach and search and potentially be sidetracked from the driving, especially if something has fallen on the floor or slipped between the seats or between a seat and the door on either side, not to mention articles that have found their way underneath the pedals. Even for items placed on the passenger seat, it often takes the driver's attention away when fumbling for a specific object without a fixed place. Removing the seat belt in order to reach objects out of normal range introduces an obvious additional hazard.

Aside of the inconvenience and the traffic safety aspect, reaching over to the glove compartment or over to the pocket on the door on the passenger side, will also for many drivers mean the risk of pulling muscles or straining the back or neck.

This innovation is also a solution to keeping children in the back seat separated and entertained, where food, beverages, toys and games need a secure place, both to protect the interior of the car, keep the children happy and entertained, and the driver less distracted by unruly kids.

A multitude of partial solutions to the overall problem of organizing loose articles around the driver of a vehicle have been patented, only some of which are commercially available. All, however, whether actively marketed or not, have limitations because they are designed to organize just a select few, predetermined articles without being adaptable to individual needs or to the driver's changing wants over time. Few of the patents offer a safe and easily operated restraining mechanism, and as far as has been determined through a world-wide patent search, none offers a leveling mechanism that accommodates all seat types and slant angles. Another common shortcoming is lack of mobility to alternate vehicles or to different seat location to accommodate changing passenger seating.

A common and increasingly more serious problem is the stress and inconvenience, associated traffic hazards, and risk of injury when the driver of an automobile occasionally reaches for various items kept on the dash board, on an empty passenger seat, in the back seat, in the glove compartment, in an armrest console, in door pockets on both sides, in back rest pockets, or from the floor of the vehicle. Aside of the inconvenience and the traffic safety aspect, reaching over to the glove compartment or over to the pocket in the door on the passenger side, will also for many drivers mean the risk of pulling muscles or straining back or neck, in addition to being off balance and distracted if the traffic conditions suddenly change. Even a momentary distraction often inadvertently leads to the vehicle straying off course.

A somewhat related problem is children in the back seat in need of being entertained and heaving a means of keeping toys, games, reading material, snacks, etc., in place. In addition to impaired travel experience for the children, lack of organization within their own environment tends to add to the stress on the driver, which again can be a traffic hazard.

Common for patented automobile seat organizing trays and boxes is a lack of emphasis on the safety aspect of disorganized surroundings for a driver of a vehicle. U.S. Pat. No. 5,551,616, Portable vehicle organizing container (1996), is confined to holding only a certain predetermined selection of items mainly used by traveling businessmen, while UK patent GB2214884A (1989) limits its claim to holding a notebook and pencil on the passenger seat. Japanese patent JP8290747A2 (1996) is only a tissue paper holder, while the more recent JP2000168420A2 (2000) claims a passenger seat table on which sundry items can be placed; however, the table is unsecured and the patent limited in scope.

### OBJECTS AND ADVANTAGES

The overall object of this invention is to provide a universal and easily adaptable solution to the problem of organizing the various articles often found around the driver of motor vehicles, both for the comfort of the driver and the safety of him and surrounding traffic. With this invention additional desirable, useful and safety enhancing utilities can be introduced in an organized and safe manner, instead of adding to the clutter often surrounding the driver.

The advantage of the invention is that it can easily be tailor-made and adapted to individual needs, whether the driver is a man or a woman, a business person or pleasure traveler, whether professional driver or private person. As the driver's needs and habits change over time, the unit can easily be modified with new utilities and alternate containers designed to hold specific items securely for convenient retrieval when needed or wanted. The same basic solution is adaptable to passengers in the back seat, both commuters in need of work surface, beverage holders, and the like, and children with a need to keep toys, games, reading material, etc., organized and a device that both serves as a tabletop and game board, as well as a separation between children.

Further objects and advantages of this invention will become apparent from consideration of the drawings and ensuing description.

### SUMMARY

The innovation, a container that utilizes an empty passenger or back seat, is designed to hold any and all items that may be needed or wanted by the driver of a vehicle, whether passenger car or van, taxi, delivery vehicle, pickup, truck, etc. The container can be customized to meet individual storage and organizing needs, is held in place on the seat to prevent movement in case of abrupt change in speed and may be easily detached, moved and carried to make the passenger seat available or to take out of the vehicle for various reasons. It has an easily operable mechanism to keep it level on slanted seats and is designed so that the four sidewalls may be packed flat together with the bottom part for compact storage and shipping, yet easily and quickly snapped together by the end user without the need for tools.

The innovation is not limited to empty passenger seats, but may also be used on empty airline or bus seats or in the back seat of automobiles for holding objects, including toys, games, snacks, etc., for children, as well as keeping children apart and occupied.

A special adjustable rack attached in the back seat serves the dual purpose of holding in place same or similar container for kids in the back seat or for storing the driver's container when the front passenger seat is not available.

### DRAWINGS

FIG. 1 shows top side, left side, and rear side views of the utility container, consisting of the base container with adjustable leveling mechanism and associated fasteners.

FIG. 2 shows an example of a holding container fastened to the bottom plate of the utility container by means of Velcro.

FIG. 3 shows an example of a holding container fastened to the bottom plate of the utility container by means of Lego- or peg board type legs that fit into holes in the bottom plate.

FIG. 4 shows the utility container fastened on the passenger seat by means of a strap around the back rest and the leveling plate adjusted for horizontal positioning on the slanted seat.

### LIST OF REFERENCE NUMERALS

1) Identical side pieces (2), with slots for tight fit with end pieces
2) Identical end pieces (2) that fit tightly into slots in side pieces
3) Bottom plate covered with Velcro, held in place by side and end pieces
4) Adjustable leveling plate
5) Typical holding containers for sundry articles
6) Wing nut screw for holding leveling plate in place
7) Velcro
8) Bottom plate with Lego- or peg board type holes, held in place by side and end pieces
9) Strap to keep utility container fastened on the seat

### DETAILED DESCRIPTION

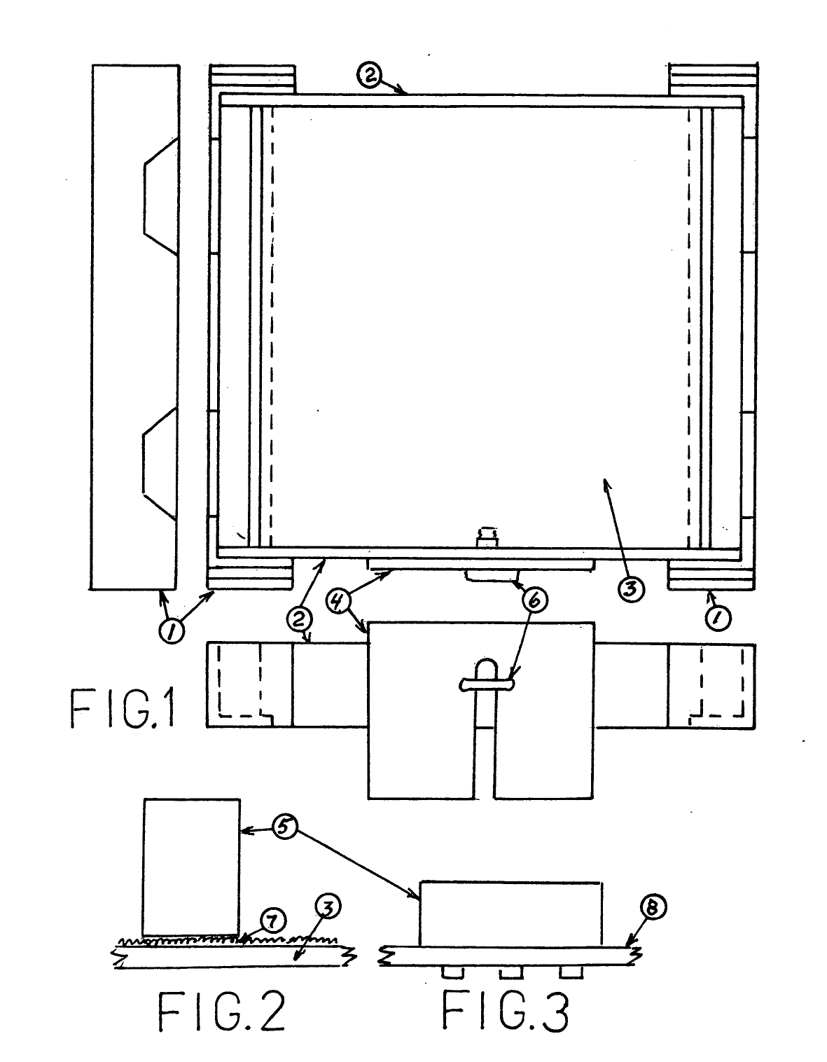

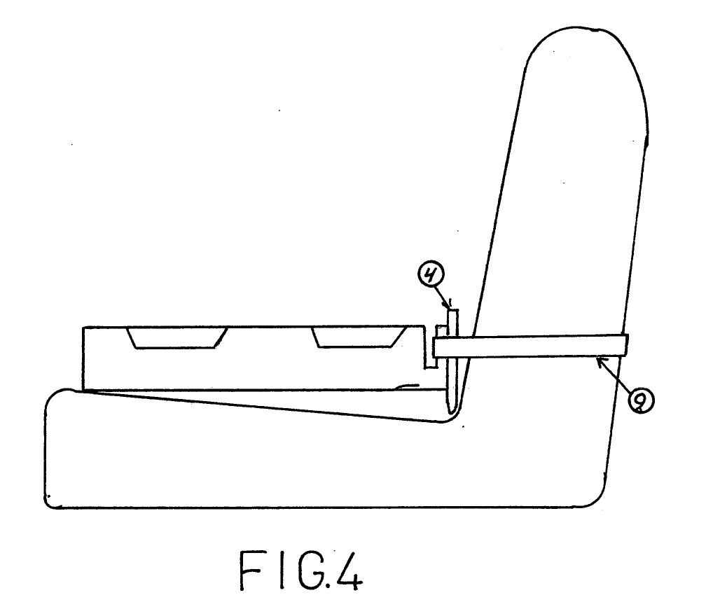

### Preferred Embodiment—FIGS. 1-4

The base container is made out of a suitable and sufficiently strong material, for example metal or molded plastic and may cover a part of or the entire area of an automobile passenger seat or center of back seat. It may be equipped with an adjustable leveling mechanism that elevates the rear side of the container to a horizontal position when placed in a slanted seat; however, easily adjustable when the unit is taken out of a seat and placed on a level surface. To prevent movement in case of abrupt changes in speed, the container is held in place by means of a mechanism in the back that optionally either utilizes already existing seat belt or a separate strap around the back rest or by other optional means. The attachment to the container is easily detachable to facilitate quick release when it is to be removed from the seat.

The container consists of a bottom part and four interlocking side pieces that easily snap together when assembled. For the back seat a holding frame serves the dual purpose of holding a similar container between children, or on the side of a single child, and for storing the driver's container when he wants it out of the way, yet reachable from the driver's seat.

The container holds an assortment of customized, replaceable and interchangeable smaller containers that are designed to hold in place the various objects that a driver or back seat passengers may want or need to keep organized in a safe and convenient manner. The containers are held in place on the bottom in a secure manner, for example by means of Velcro or with Lego-compatible locking underneath each container that fits into a Lego- or peg board type bottom plate.

In addition to a variety of containers customized to hold the various objects that a driver may be interested in carrying, a power box may be hooked up to the cigarette lighter or powered by a separate battery to power a utility light and outlets for charging objects like cell phones and the like. A fixed or collapsible stand or rack may hold maps, directions and other documents that the driver may wish to have displayed for easy reference, optionally made more readable in the dark using the utility light.

The organizer may be offered in both standard and luxury models, the latter for example with leather cover to match the interior of luxury cars, personalized imprint, etc.

### Operation of Invention

### Additional Embodiment

The base container is placed on the empty seat, either on the empty passenger side or in the back to serve other passengers, including children, leveled by releasing the level mechanism until a horizontal position is achieved and then fastened in the back to secure stability. This may involve using already existing seat belt hooked inside hooks provided in the back of the container or a special strap around the back of the seat or other optional restraining mechanism.

The user will optionally place items needed while driving directly into the container, or select those smaller containers or boxes most suitable for holding the objects of his or her particular interest and insert them into the base container in the configuration that best meets individual needs. As time goes by, as needs change and additional containers are made available from the manufacturer/distributor, the content and layout may be changed and optimized.

The user will organize the various objects into the containers available and establish a certain conformity so that he can reach what he needs without too much searching or distraction while driving. Optimization may take some trial and error and adjustment in the beginning until the best layout and container utilization is achieved. An optional utility light may provide sufficient light for writing notes, reading directions, checking a map or the like, preferably when pulled over for safety reasons

### CONCLUSION, RAMIFICATIONS, AND SCOPE

While the above description contains many specificities, these should not be construed as limitations on the scope of the invention, but rather as an exemplification of some preferred embodiments thereof. Many other variations are possible. For example, the utility has a wide range of potential applications for entertaining kids in the back seat of an automobile, providing both a container for holding various toys etc., as well as providing a leveled game board and a separation between two or more children.

In commuter vans the utility container may serve both as a drink holder and support for card games, etc., while the assembly may be offered as optional accessory for new automobiles and made available in various colors. Up-scale automobile owners may want a luxury version of the utility, and rental car companies may offer it as an accessory at a surcharge.

Accordingly, the scope of the invention should be determined not by the embodiments illustrated, but by the appended claims and their legal equivalents.

1. An organizing container suitable for placement on an empty passenger seat or in the back seat, comprising
1) a bottom part, optionally with a means of keeping content securely in desired position, and four interlocking sidewalls,
2) a mechanism for holding said container in place on the seat,
3) a mechanism for leveling said container if the seat is slanted,
4) an assortment of optional customized, interchangeable, insertable boxes designed to hold in fixed place the various items of interest to the driver, optionally with a bottom designed to hold said boxes in fixed place by means of Lego- or peg board type legs, Velcro or other means,
5) an optional work light that feeds off a battery or the automobile's cigarette lighter, optionally with additional outlets for recharging cell phones and other rechargeable objects, powering razors, etc.
6) side compartments suitable for holding clipboard with maps and directions, as well as mail for posting and other documents like shopping lists, store coupons, and parking receipts in a convenient position,
7) a means of adding customized boxes as new or additional needs are recognized,
8) an optional holding rack attachable to the back seat, holding said container for passengers in the back or the driver's container when passenger seat is occupied.
